(19) United States
(12) Patent Application Publication
(10) Pub. No.: US 2019/0303742 A1
(43) Pub. Date: Oct. 3, 2019

(54) EXTENSION OF THE CAPSULE NETWORK

(71) Applicant: CA, Inc., New York, NY (US)

(72) Inventor: Christopher Phillip Bonnell, Longmont, CO (US)

(21) Appl. No.: 15/943,445

(22) Filed: Apr. 2, 2018

(51) Int. Cl. G06N 3/04; G06N 3/08; G06F 17/16

(52) U.S. Cl. CPC G06N 3/04; G06F 17/16; G06N 3/08

(57) ABSTRACT

A capsule neural network is extended to include a factorization machine and two factor matrices. The factor matrices can be low rank matrices that are substituted for a trainable matrix in conventional capsules. The factor matrices can be differentially trained using the factorization machine. Because the factor matrices have substantially fewer elements than the trainable matrix, a capsule network can be trained in less time and use less memory than required for conventional capsule networks.

### BACKGROUND

The disclosure generally relates to the field of data processing, and more particularly to modeling, design, simulation, or emulation.

Neural networks simulate the operation of the human brain to analyze a set of inputs and produce outputs. In conventional neural networks, neurons (also referred to as perceptrons) can be arranged in layers. Neurons in the first layer receive input data. Neurons in successive layers receive data from the neurons in the preceding layer. A final layer of neurons produces an output of the neural network. Capsule networks are a recent advancement in artificial neural networks which enable individual neuron units to capture and manipulate significantly more data. In a capsule network, a capsule can be thought of as a group of neurons that operate together to perform some recognition, decision making, detection, or other task.

Capsule networks have improved machine recognition in various ways. For example, capsule networks can maintain associations between parts of an image so that object relationships in image data can be recognized. Further, capsule networks can better recognize objects that may be rotated and translated differently than in the training data.

However, neural networks in general take a lot of time, data, and space to train, and capsule networks are no exception. Capsules operate in sets of input vectors rather than a single input vector. Further, capsules include internal matrices that are not necessarily present in a generalized neural network. Further, the number of free parameters in capsule networks can grow quadratically, thereby adding more stress to the time, memory, and processor resources of a training system. As a result, capsule networks may be slow to train.

### BRIEF DESCRIPTION OF THE DRAWINGS

Aspects of the disclosure may be better understood by referencing the accompanying drawings.

FIG. 1 is a block diagram illustrating an example system for training and deploying a capsule network.

FIG. 2 is a block diagram illustrating an example capsule network.

FIG. 3 is a block diagram illustrating an example capsule.

FIG. 4 illustrates the substitution of two smaller matrices, factor matrix A and factor matrix B for a trainable transformation matrix W.

FIG. 5 is a flow chart illustrating operations of a method for training a capsule network having factorization machine extensions according to embodiments.

FIG. 6 depicts an example computer system for operating a trinary neural network.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

### Overview

Embodiments of the disclosure include a capsule neural network that is extended to include a factorization machine and two factor matrices. The factor matrices can be low rank matrices that are substituted for a trainable matrix in conventional capsules. The factor matrices can be differentially trained using the factorization machine. Because the factor matrices have substantially fewer elements than the trainable matrix, a capsule network can be trained in less time and use less memory than required for conventional capsule networks.

### Example Illustrations

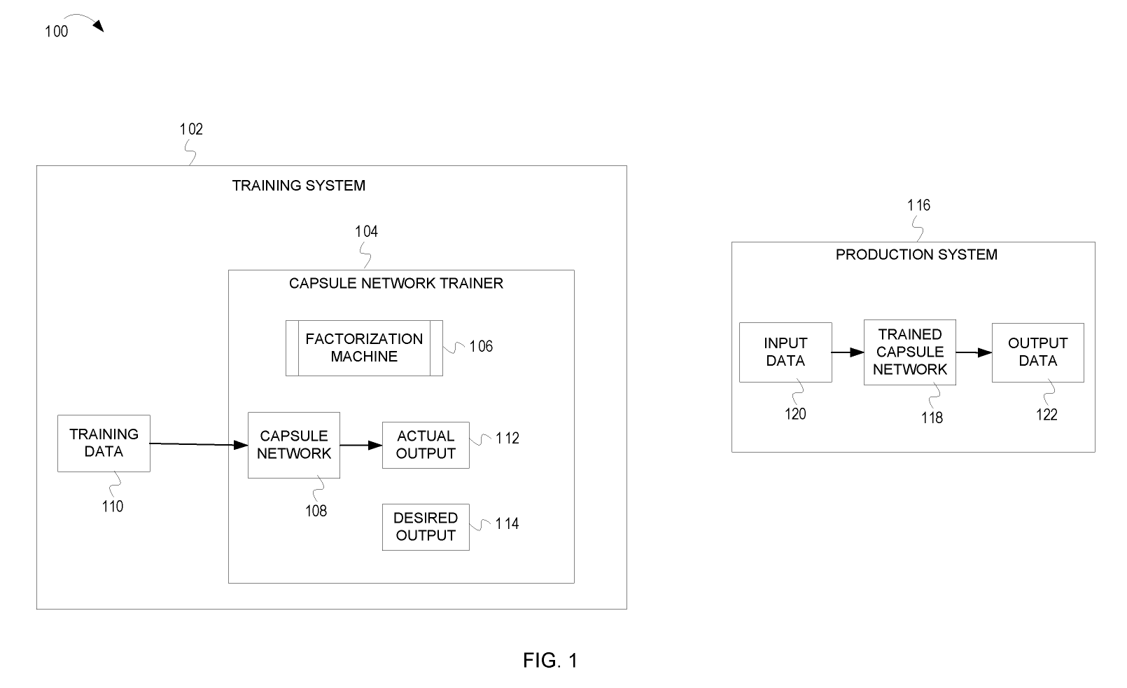

FIG. 1 is a block diagram illustrating an example system 100 for training and deploying a capsule network. In some embodiments, system 100 includes a training system 102 and a production system 116. Training system 102 can be a suitably configured computer system with sufficient processor, memory and other computing resources to allow the training system 102 to train a capsule network 108 in an acceptable time frame. For example, the training system 102 may be configured with both standard processors and special purpose processors, e.g., auxiliary processing units such as graphical processor units (GPUs), that can be configured for training a capsule neural network 108.

Training system 102 can include a capsule network trainer 104. In order to train capsule network 108, capsule network trainer 104 reads training data 110, and passes the data through a current configuration of capsule network 108. The capsule network 108 produces actual output 112, which can be compared with a desired output 114 associated with the training data. Capsule network trainer 104 can adjust parameters of the capsule network 108 based on the difference between the desired output 114 and the actual output 112. In particular, capsule network trainer 104 can use novel training techniques described in further detail below to train a capsule network 108.

Capsule network trainer 104 can include a factorization machine 106. A factorization machine 106 models interactions between features (explanatory variables) using factorized parameters. The factorization machine can estimate interactions between features even when the data is sparse. Factorization machine 106 can be used during the training of capsule network 108 to train two relatively low rank matrices in a capsule that replace a higher rank matrix used in conventional capsule network training. The factorization machine can utilize different learning methods. Such methods include stochastic gradient descent, alternating least squares, and Markov Chain Monte Carlo inference. In some embodiments, stochastic gradient descent is used. Details on the operation of factorization machine 106 can be found in Steffen Rendle, “Factorization machines”, 2010 IEEE 10th International Conference on Data Mining (ICDM). IEEE, 995-1000; which is hereby incorporated by reference herein for all purposes.

After the training system 102 has completed training the capsule network 108, it can be deployed to production system 116 as trained capsule network 118. Production system 116 can use the trained capsule network 118 to receive input data 120, and pass the input data 120 through the trained capsule network 118 to obtain output 122.

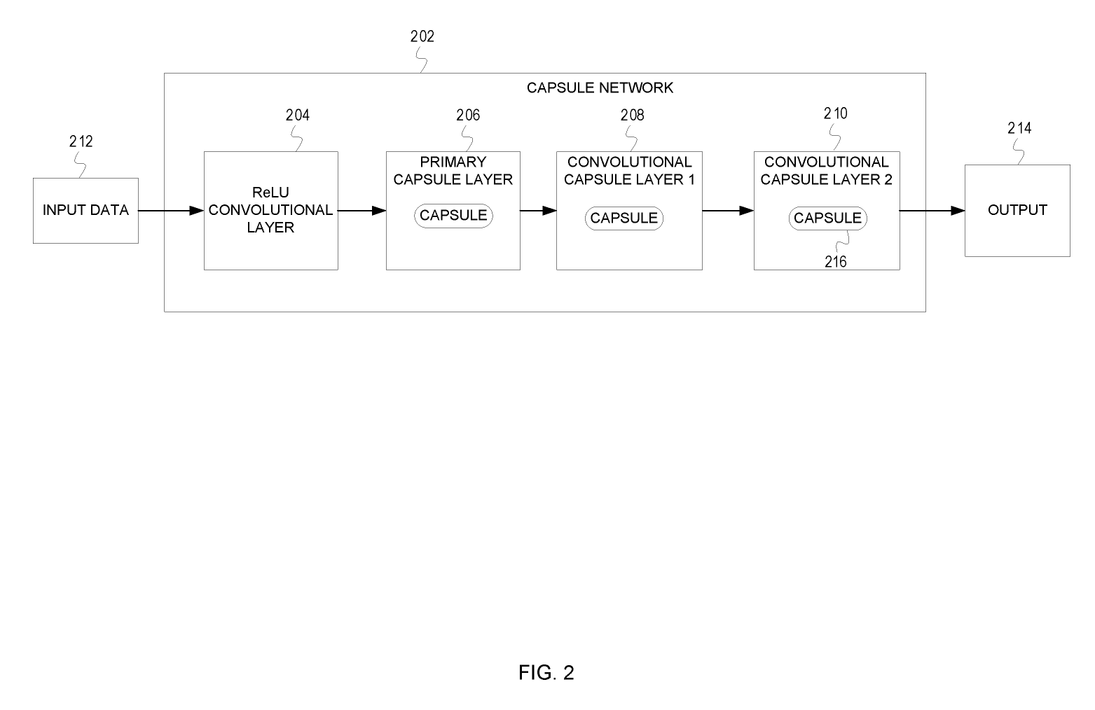

FIG. 2 is a block diagram illustrating an example capsule network 202. The example capsule network 202 can include a Rectified Linear Unit (ReLU) convolutional layer 204, a primary capsule layer 206, and two convolutional capsule layers 208 and 210. The capsule layers, primary capsule layer 206 and the two convolutional capsule layers 208 each include multiple capsules 216. Input data 212 passes first through ReLU convolutional layer 204, which processes the input data and provides layer output to primary capsule layer 206. Capsules in primary capsule layer 206 can activate depending on their input data. Upon activation, the output of a capsule is routed to one or more capsules in the succeeding layer. For example, output from activated capsules in the primary capsule layer 206 is provided as input to capsules in convolutional capsule layer 1 208. Similarly, output from activated capsules in convolutional capsule layer 1 208 is provided as input to convolutional capsule layer 2 210. The output of activated capsules in convolutional layer 2 210 comprises the output 214 of the capsule network 202. Details on the operation of a capsule network can be found in Geoffrey Hinton et al., “Matrix Capsules with EM Routing” ICLR 2018; which is hereby incorporated by reference herein for all purposes.

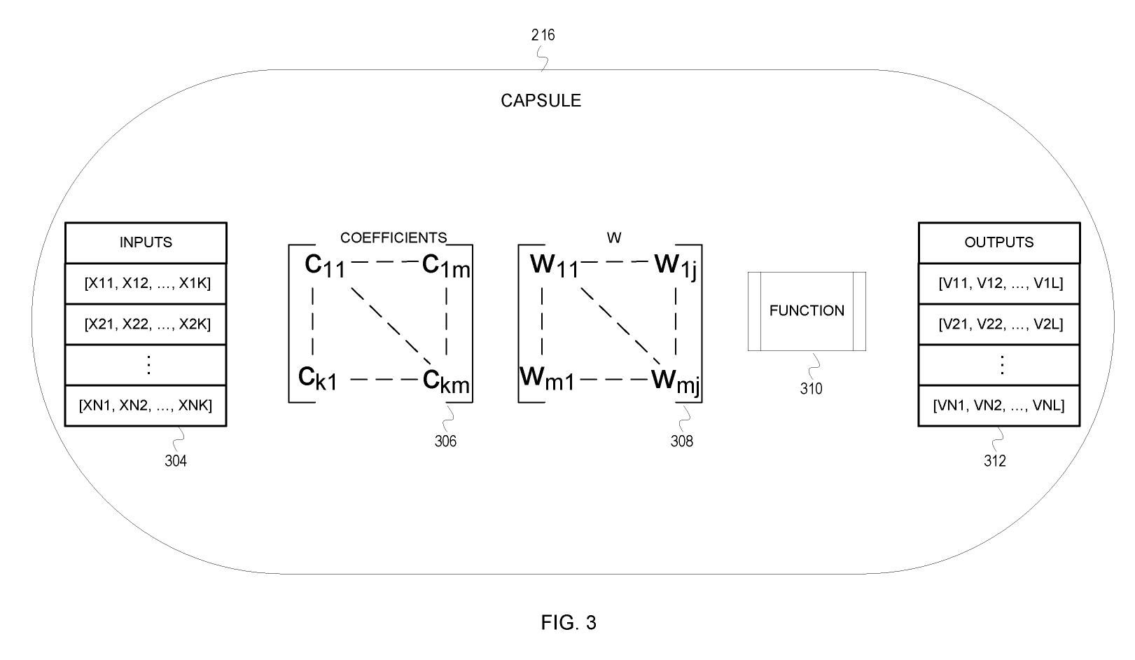

FIG. 3 is a block diagram illustrating an example capsule 216. Capsule 216 can include a set of inputs 304, a coefficient matrix 306, a trainable transformation matrix W 308, a function 310, and a set of outputs 312. The set of inputs 304 can be a set of n input vectors X₁- Xₙ. Each of the input vectors X has a size of k. The vectors in inputs 304 are input to the coefficient matrix 306. The coefficient matrix 306 can perform transformations of the input vectors that are particular to a capsule or capsule type. For example, in the case of image data, coefficient matrix 306 can rotate or translate the input image data. Output of the coefficient matrix 306 is provided as input to the trainable transformation matrix W 308. The output of trainable transformation matrix W 308 can be provided to a function 310. In some embodiments, the function 310 is a sigmoid squashing function. Outputs 312 is a set of vector output from function 310, and are the output of the capsule 302 to capsules in the next layer of the capsule network.

The size of trainable transformation matrix W 308 can get quite large depending on the size of the input vectors, output vectors, and coefficient matrix. Thus, conventional methods of training the trainable transformation matrix W 308 can consume a large amount of system resources such as memory and processor time. Embodiments thus substitute two smaller factor matrices for trainable transformation matrix W when training a capsule network.

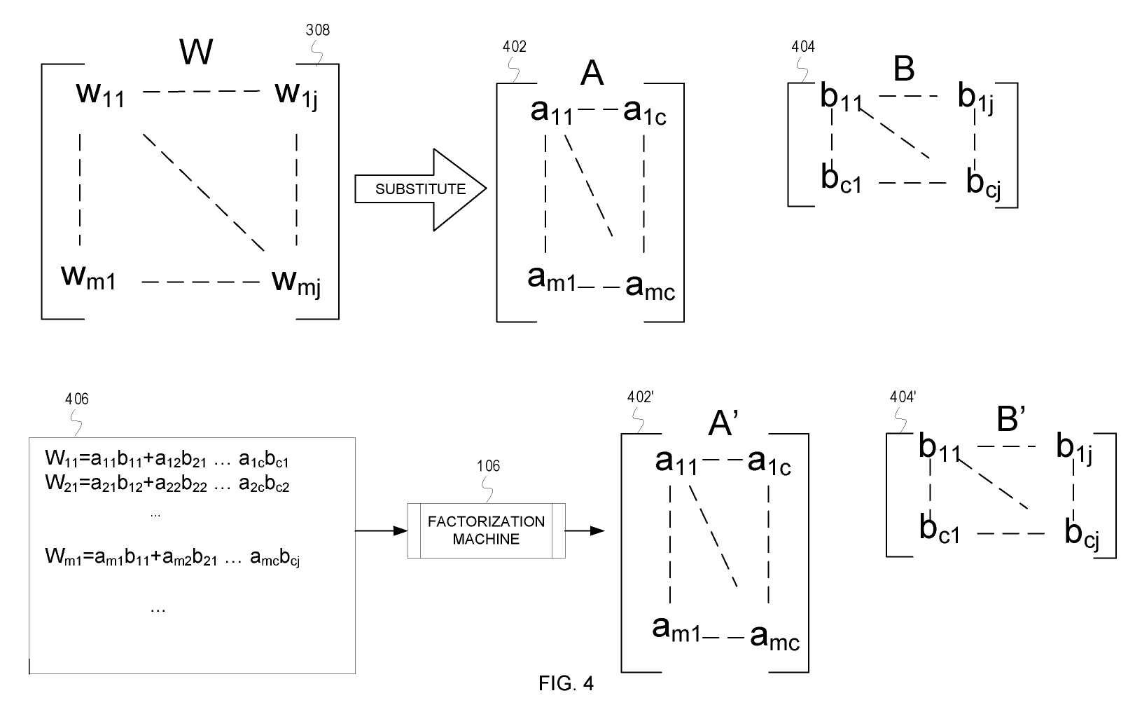

FIG. 4 illustrates the substitution of two smaller matrices, factor matrix A 402 and factor matrix B 404 for trainable transformation matrix W 308. A parameter c can be used to determine the dimensions of factor matrix A 402 and factor matrix B 404. The parameter c will be referred to as a factor matrix inner dimension. An initial value for parameter c can be provided as input when training a capsule network. Thus, for a given trainable transformation matrix W 308 having dimensions m×j, and a given c, the dimensions of factor matrix A 402 are m×c, and the dimensions of factor matrix B 404 are c×j. The choice of a particular value for c can be influenced by the desirability of smaller matrices in training due to fewer elements to train versus the likelihood that the capsule network will converge. Smaller values for c can result in a capsule network that may be trained more quickly using fewer resources at the risk of an inability for the capsule network to converge. Larger values for c can result in a capsule network that takes longer to train, but is more likely to converge. The inventor has discovered that values of c between 3 and 6 provide a reasonable training time with a reasonable probability that the capsule network will converge.

During a training phase of a capsule network, an actual output of the capsule network is compared to a desired output for the network. The results of the comparison are changes (differences) required to entries of trainable transformation matrix A 408. Instead of applying these changes directly to W, a system of equations 406 can be created in accordance with the matrix multiplication rules that would apply to create trainable transformation matrix W 308 from factor matrix A 402 and factor matrix B 404. The system of equations can be provided to factorization machine in order to determine changes required in the factor matrix A 402 and B 404. The output of the factorization machine are new entries for factor matrix A 402 and factor matrix B 404. The training process can be repeated until the entries of factor matrix A 402 and factor matrix B 404 converge within an acceptable tolerance. The resultant factor matrix A′ 402′ and factor matrix B′ 404′ can then be used to recreate trainable transformation matrix W 308 by multiplying factor matrix A′ 402′ and factor matrix B′ 404′.

Because there are substantially fewer entries in factor matrix A 402 and factor matrix B 404 when compared with trainable transformation matrix W 308, the training phase for a capsule network can typically be performed in less time, using less memory and overall processor time. Additionally, because there are fewer entries in factor matrix A 402 and factor matrix B 404, there is substantially less likelihood of overfitting when compared with conventional capsule network training.

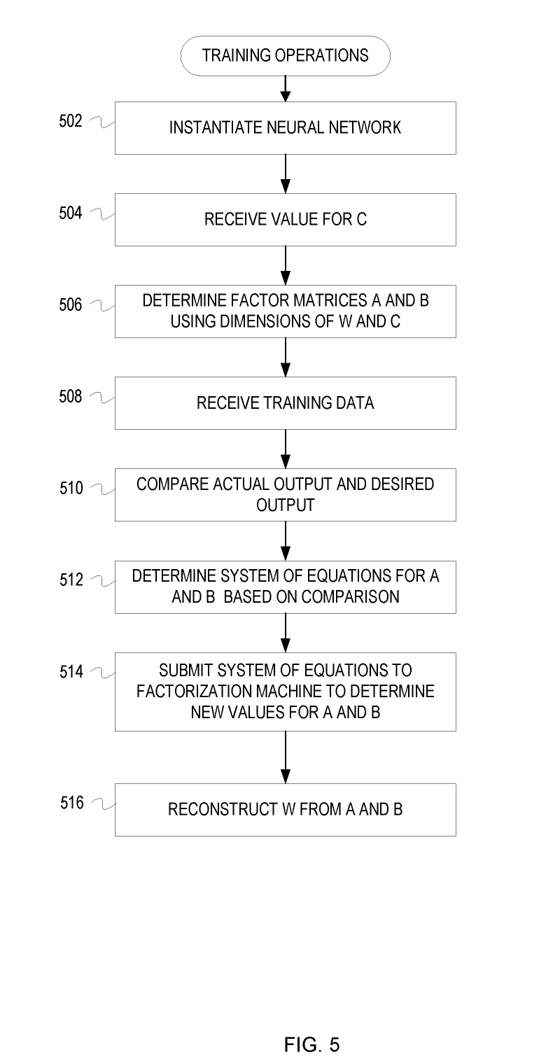

FIG. 5 is a flow chart 500 illustrating operations of a method for training a capsule network having factorization machine extensions according to embodiments. At block 502, a capsule network is instantiated. The capsule network can be instantiated in various ways. For example, a partially trained capsule network can be instantiated by reading the capsule network configuration (e.g., the layers, capsules, and other stored capsule data) from one or more machine-readable media. Alternatively, a new capsule network, i.e., a capsule network to be trained, can be instantiated by configuring the layers and capsules in the new capsule network.

At block 504, the capsule network trainer receives a value for the parameter c. The value can be received via a user input, read from configuration data or environment variables, or hardcoded.

At block 506, a factor matrix A and a factor matrix B can be created for a capsule based on c and the dimensions of a trainable transformation matrix of the capsule.

At block 508, a capsule receives training data. The training data can be processed by the capsule using the coefficient matrix, trainable transformation matrix, and function (e.g., sigmoid squashing function) associated with the capsule. The output of the capsule can be provided to capsules in a subsequent layer of the capsule network.

At block 510, the actual output of a capsule network with respect to a particular set of training inputs is compared with the desired output for the particular set of training inputs.

At block 512, a system of equations is determined based on the comparison performed at block 512. The equations relate changes to entries in trainable transformation matrix W as determined from the comparison at block 510 to the entries in factor matrix A and factor matrix B.

At block 516, the system of equations is submitted to a factorization machine. The factorization machine approximates a solution to the system of equations. Because the number of variables in the system of equations can be quite large, an exact solution is not likely or even possible to be produced by the factorization machine. Thus, the factorization machine produces an approximation within a configurable or predefined tolerance. The factorization machine can determine new values for factor matrix A and factor matrix B.

At block 518, a new trainable transformation matrix W can be created by performing matrix multiplication of the current factor matrix A and factor matrix B.

Blocks 508-518 can be repeated until the capsule network converges within an acceptable tolerance. If the network does not converge within an acceptable time frame or number of iterations, the value of c can be adjusted up and the training process repeated.

Some embodiments of the above-described systems and methods can provide improvements over conventional capsule network training systems. In conventional capsule network training systems, the order of complexity is typically O(n²). In some embodiments, the order of complexity is O(n). Thus, embodiments can provide a capsule network training system that can be more efficient than conventional training systems, resulting in less time and resources in training a capsule network. Further, because the factor matrices are smaller, the system can use less memory, or can be used to train larger capsule networks. Further, because there are fewer parameters to train in the small factor matrices, there is less risk of overfitting in some embodiments than in conventional capsule network training systems.

The examples often refer to a “capsule network trainer.” The capsule network trainer is a construct used to refer to implementation of functionality for training a capsule network using extensions such as a factorization machine. This construct is utilized since numerous implementations are possible. Any of the components of a capsule network trainer may be a particular component or components of a machine (e.g., a particular circuit card enclosed in a housing with other circuit cards/boards), machine-executable program or programs, firmware, a circuit card with circuitry configured and programmed with firmware for training a capsule network, etc. The term is used to efficiently explain content of the disclosure. Although the examples refer to operations being performed by a capsule network trainer, different entities can perform different operations. For instance, a dedicated co-processor or application specific integrated circuit can perform some or all of the functionality of the capsule network trainer.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

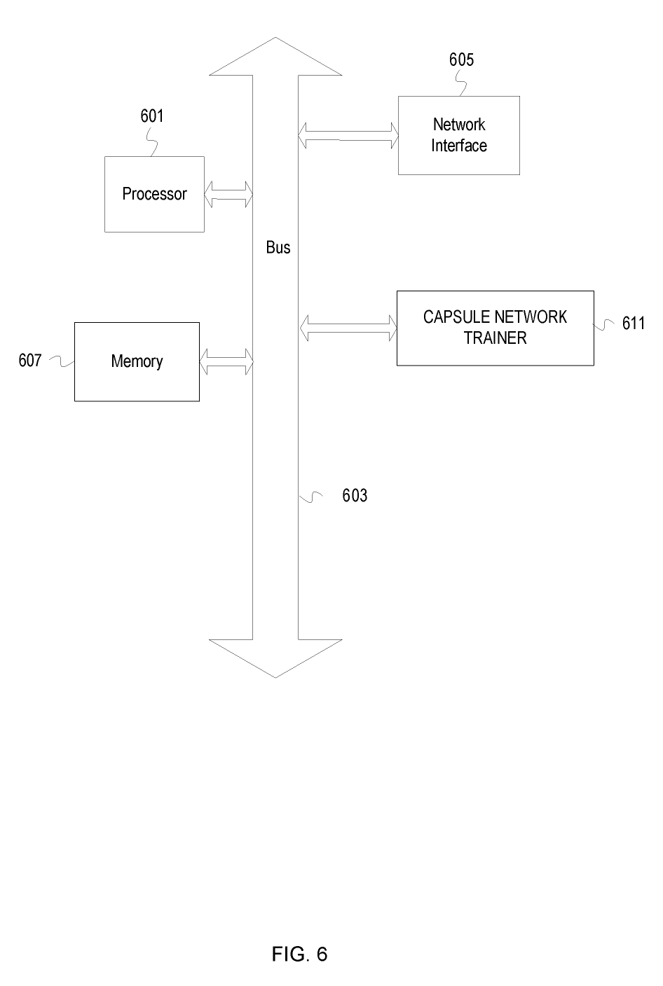

FIG. 6 depicts an example computer system training a capsule network. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes capsule network trainer 611. The capsule network trainer 611 can perform some or all of the functionalities described above to train a capsule network. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for training a capsule network using extensions such as a factorization machine as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
instantiating a capsule network having a plurality of capsules arranged in one or more layers, wherein each capsule includes a trainable transformation matrix;
receiving a value for a factor matrix inner dimension;
determining a first factor matrix and a second factor matrix for a capsule, wherein the first factor matrix and the second factor matrix have dimensions based on dimensions of the trainable transformation matrix and the factor matrix inner dimension;
receiving training data for the capsule network;
comparing actual output of the capsule network with desired output associated with the training data;
determining a system of equations associated with the first factor matrix and the second factor matrix based, at least in part, on differences determined by comparison of the actual output with the desired output; and
supplying the system of equations to a factorization machine to determine updated values for entries in the first factor matrix and the second factor matrix.

2. The method of claim 1 further comprising:
reconstructing the trainable transformation matrix using the first factor matrix and the second factor matrix.

3. The method of claim 1, wherein the value of the factor matrix inner dimension is greater than or equal to three (3) and less than or equal to six (6).

4. The method of claim 1, further comprising:
Increasing the value of the factor matrix inner dimension based on determining that the capsule network is not converging.

5. The method of claim 1, further comprising configuring the factorization machine to utilize stochastic gradient descent as a learning mode.

6. One or more non-transitory machine-readable media comprising program code for training a capsule network, the program code to:
instantiate a capsule network having a plurality of capsules arranged in one or more layers, wherein each capsule includes a trainable transformation matrix;
receive a value for a factor matrix inner dimension;
determine a first factor matrix and a second factor matrix for a capsule, wherein the first factor matrix and the second factor matrix have dimensions based on dimensions of the trainable transformation matrix and the factor matrix inner dimension;
receive training data for the capsule network;
compare actual output of the capsule network with desired output associated with the training data;
determine a system of equations associated with the first factor matrix and the second factor matrix based, at least in part, on differences determined by comparison of the actual output with the desired output; and
supply the system of equations to a factorization machine to determine updated values for entries in the first factor matrix and the second factor matrix.

7. The one or more non-transitory machine-readable media of claim 6, wherein the program code further includes program code to:
reconstruct the trainable transformation matrix using the first factor matrix and the second factor matrix.

8. The one or more non-transitory machine-readable media of claim 6, wherein the value of the factor matrix inner dimension is greater than or equal to three (3) and less than or equal to six (6).

9. The one or more non-transitory machine-readable media of claim 6, wherein the program code further comprises program code to:
increase the value of the factor matrix inner dimension based on a determination that the capsule network is not converging.

10. The one or more non-transitory machine-readable media of claim 6, wherein the program code further comprises program code to configure the factorization machine to utilize stochastic gradient descent as a learning mode.

11. An apparatus comprising:
at least one processor; and
a non-transitory machine-readable medium having program code executable by the at least one processor to cause the apparatus to,
instantiate a capsule network having a plurality of capsules arranged in one or more layers, wherein each capsule includes a trainable transformation matrix;
receive a value for a factor matrix inner dimension;
determine a first factor matrix and a second factor matrix for a capsule, wherein the first factor matrix and the second factor matrix have dimensions based on dimensions of the trainable transformation matrix and the factor matrix inner dimension;
receive training data for the capsule network;
compare actual output of the capsule network with desired output associated with the training data;
determine a system of equations associated with the first factor matrix and the second factor matrix based, at least in part, on differences determined by comparison of the actual output with the desired output; and
supply the system of equations to a factorization machine to determine updated values for entries in the first factor matrix and the second factor matrix.

12. The apparatus of claim 11, wherein the program code further includes program code to:
reconstruct the trainable transformation matrix using the first factor matrix and the second factor matrix.

13. The apparatus of claim 11, wherein the value of the factor matrix inner dimension is greater than or equal to three (3) and less than or equal to six (6).

14. The apparatus of claim 11, wherein the program code further comprises program code to:
increase the value of the factor matrix inner dimension based on a determination that the capsule network is not converging.

15. The apparatus of claim 11, wherein the program code further comprises program code to configure the factorization machine to utilize stochastic gradient descent as a learning mode.
